(19) United States
(12) Patent Application Publication
(10) Pub. No.: US 2022/0090681 A1
(43) Pub. Date: Mar. 24, 2022

(54) MECHANISM FOR SEALING CYLINDER AND CYLINDER HEAD

(71) Applicant: GUANGZHOU ANTU ELECTRIC CO., LTD., Guangzhou (CN)

(72) Inventor: Xinhua Kuang, Guangzhou (CN)

(21) Appl. No.: 17/099,595

(22) Filed: Nov. 16, 2020

(30) Foreign Application Priority Data
Sep. 21, 2020 (CN) 202022084976.5

(51) Int. Cl. F16J 15/02; F04B 53/16

(52) U.S. Cl. CPC F16J 15/021; F04B 53/16

(57) ABSTRACT

The disclosure provides a mechanism for sealing cylinder and cylinder head, comprising a gas outlet portion of the cylinder, the cylinder head and a seal structure; wherein the gas outlet portion is provided with an outlet and a position-retaining protruding edge surrounding an outside of the outlet; the seal structure comprises a first sealing ring arranged inward of the position-retaining protruding edge and comprises a heat insulating sheet, wherein the heat insulating sheet covers the first sealing ring to seal the outlet; the cylinder head covers the gas outlet portion, and a movable member and an elastic member configured to tightly press the movable member against the heat insulating sheet are arranged inside the cylinder head.

### CROSS-REFERENCE TO PRIOR APPLICATION

This application claims the benefit of the priority of Chinese Patent Application No. 202022084976.5 filed on Sep. 21, 2020, the contents of which are incorporated herein by reference.

### TECHNICAL FIELD

The disclosure of cylinder and cylinder head mechanism particularly relates to a mechanism for sealing cylinder and cylinder head.

### BACKGROUND

Existing pumps and cylinders conventionally use plastic sealing rings to achieve air sealing. In such case, the sealing component is pressed against the sealing ring by the action of the spring, to achieve internal sealing of the pump. During use of the pump, displacement of the sealing component is achieved when the pressure of the gas inside the pump is applied to the sealing component to overcome the force of spring, thereby realizing outward gas transmission. During the gas transmission, due to the spring force and the pressure, friction is frequently generated between the sealing component and the sealing ring. In such case, the sealing ring may be melted due to a high temperature caused by the friction, which may result in seal failure.

### SUMMARY

One goal of the embodiments of the disclosure is to provide a mechanism for sealing cylinder and cylinder head, which has improved sealing performance.

In order to achieve the above goal, the embodiments of the disclosure provides a mechanism for sealing cylinder and cylinder head, comprising a gas outlet portion of the cylinder, the cylinder head and a seal structure;

The gas outlet portion is provided with an outlet and a position-retaining protruding edge surrounding the outside of the outlet;

The seal structure comprises a first sealing ring arranged inward of the position-retaining protruding edge and comprises a heat insulating sheet, wherein the heat insulating sheet covers the first sealing ring to seal the outlet;

The cylinder head covers the gas outlet portion, and a movable member and an elastic member configured to tightly press the movable member against the heat insulating sheet are arranged inside the cylinder head.

Compared with the existing technologies, the mechanism for sealing cylinder and cylinder head of the disclosure, which provides the heat insulating sheet for protecting the first sealing ring from heat, solves the existing problem that the first sealing ring may be melted due to the high temperature generated during the normal operation of the cylinder, significantly protects the first sealing ring, and substantially improves service life of the whole cylinder.

In a further embodiment, the elastic member may comprise a spring, which has one end fastened to the cylinder head and another end fastened to the movable member.

In a further embodiment, the movable member and the heat insulating sheet may respectively have a flat surface, and the two flat surfaces are abutted with each other.

In a further embodiment, a mounting groove for receiving the position-retaining protruding edge may be formed in the cylinder head, and a side wall of the mounting groove may be located above the heat insulating sheet to prevent the heat insulating sheet from escaping from the position-retaining protruding edge.

In a further embodiment, a second sealing ring may be arranged at an outer periphery of the position-retaining protruding edge, and the second sealing ring seals a gap formed between the mounting groove and a side surface of the position-retaining protruding edge.

In a further embodiment, both the first sealing ring and the second sealing ring may be heat resisting sealing rings.

In a further embodiment, the gas outlet portion may be provided with a positioning groove for positioning and mounting the first sealing ring.

### BRIEF DESCRIPTION OF THE DRAWINGS

FIG. 1 is a structural drawing according to an embodiment of the disclosure;

FIG. 2 illustrates an internal structure of a gas outlet portion according to an embodiment of the disclosure.

### DETAILED DESCRIPTION OF ILLUSTRATED EMBODIMENTS

The technical solutions according to embodiments of the disclosure will be clearly and completely described below in conjunction with the accompanying drawings illustrating the embodiments of the disclosure. It is apparent that, some, but not all embodiments of the invention are described herein. All embodiments achieved by those skilled in the art based on the embodiments in the disclosure without creative work fall within the scope of the invention.

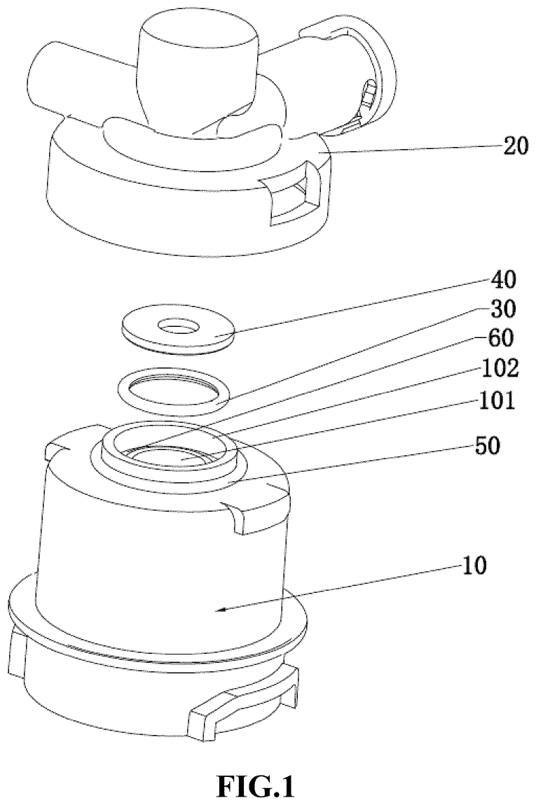

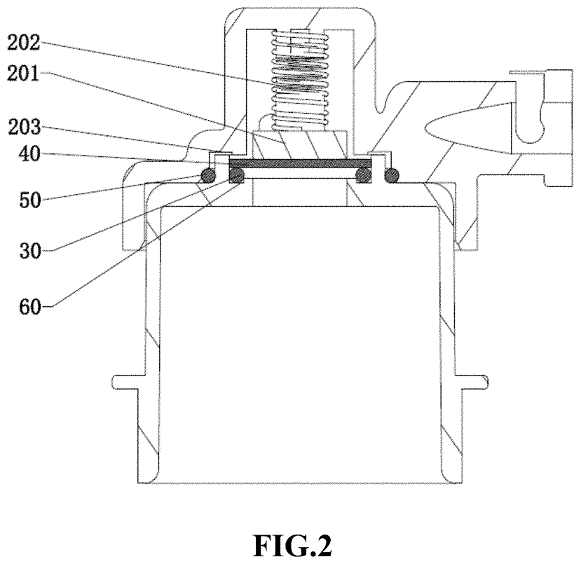

Referring to FIGS. 1 and 2, FIG. 1 is a structural drawing according to an embodiment of the disclosure, and FIG. 2 illustrates an internal structure of a gas outlet portion according to an embodiment of the disclosure.

A mechanism for sealing a cylinder and a cylinder head comprises a gas outlet portion 10 of the cylinder, the cylinder head 20 and a seal structure. The gas outlet portion 10 is provided with an outlet 101. Further, a position-retaining protruding edge 102 surrounding the outside of the outlet 101 is fixedly arranged on the gas outlet portion 10. In the embodiment, the position-retaining protruding edge 102 is coaxial with the outlet 101.

The seal structure comprises a first sealing ring 30 arranged inward of the position-retaining protruding edge 102 and comprises a heat insulating sheet 40, wherein the first sealing ring 30 abuts on an inner wall of the position-retaining protruding edge 102, and the heat insulating sheet 40 covers the first sealing ring 30.

The cylinder head 20 covers the gas outlet portion 10. Inside the cylinder head 20, a mounting cavity is formed, in which a movable member 201 and an elastic member 202 are arranged. Herein, the movable member 201 is tightly pressed against the heat insulating sheet 40 by means of the elastic member 202. In the embodiment, the elastic member 202 may be a spring. The spring has one end fastened to the cylinder head 20 and another end fastened to the movable member 201. The spring is in a compressed state. By merely the force of the spring, the movable member 201 is tightly pressed above the first sealing ring 30, to close and seal the cylinder.

When the cylinder works normally, the pressure in the cylinder is gradually increased. When the pressure of the gas is higher than the spring force, the heat insulating sheet 40 and the movable member 201 are pushed upwards by the gas inside the cylinder as the pressure overcomes the spring force. In such case, the gas can exit through outlet the outlet 101.

Due to the spring force and the pressure, the movable member 201 is frequently moved inside the cylinder head 20. In such case, the heat generated by the friction of the movable member 201 is transmitted to the first sealing ring 30 through the heat insulating sheet 40. Since the heat is insulated by the heat insulating sheet 40, most of the heat is isolated and the heat transmitted to the first sealing ring 30 is greatly reduced. In this way, the first sealing ring 30 is prevented from melting at high temperature and thus is protected. Consequently, the gas outlet portion 10 of the cylinder has greatly improved stable sealing performance.

Preferably, in the embodiment, the movable member 201 and the heat insulating sheet 40 are arranged in such a manner that flat surfaces of the movable member 201 and the heat insulating sheet 40 are abutted with each other.

In particular, the cylinder usually is frequently displaced during operation. With the arrangement of flat abutting surfaces, stable force is applied when the heat insulating sheet 40 is pushed by the movable member 201.

Preferably, a mounting groove 203 for receiving the position-retaining protruding edge 102 is integrally formed in the cylinder head 20, and a side wall of the mounting groove 203 is located above the heat insulating sheet 40. With such arrangement, the side wall of the mounting groove 203 has a function to restrict the displacement of the heat insulating sheet 40, whereby the heat insulating sheet 40 is prevented from escaping from the position-retaining protruding edge 102. Due to the corporation of elements, the movements of the heat insulating sheet 40 opening or closing the first sealing ring 30 have high stability.

In addition, a second sealing ring 50 is sleeved on the position-retaining protruding edge 102, at the outer periphery. The second sealing ring 50 seals the gap formed between the mounting groove 203 and the side surface of the position-retaining protruding edge 102, thereby sealing and isolating inner portion of the cylinder head 20 from the environment.

It should be noted that, both the first sealing ring 30 and the second sealing ring 50 are heat resisting sealing rings.

In order to facilitate the mounting of the first sealing ring 30, the gas outlet portion 10 is provided with a positioning groove 60 for positioning and mounting the first sealing ring 30.

All the above are merely preferred embodiments of the invention. It should be noted that, those skilled in the art may obtain various modifications and equivalent arrangements included within the scope of the invention without departing from the principle of the invention.

1. A mechanism for sealing a cylinder and a cylinder head, comprising a gas outlet portion of the cylinder, the cylinder head and a seal structure,
wherein the gas outlet portion is provided with an outlet and a position-retaining protruding edge surrounding an outside of the outlet;
wherein the seal structure comprises a first sealing ring arranged inward of the position-retaining protruding edge and comprises a heat insulating sheet, and the heat insulating sheet covers the first sealing ring to seal the outlet;
wherein the cylinder head covers the gas outlet portion, and a movable member and an elastic member configured to tightly press the movable member against the heat insulating sheet are arranged inside the cylinder head.

2. The mechanism for sealing a cylinder and a cylinder head according to claim 1, wherein the elastic member comprises a spring, and the spring has one end fastened to the cylinder head and another end fastened to the movable member.

3. The mechanism for sealing a cylinder and a cylinder head according to claim 1, wherein the movable member and the heat insulating sheet respectively have a flat surface, and the two flat surfaces are abutted with each other.

4. The mechanism for sealing a cylinder and a cylinder head according to claim 1, wherein a mounting groove for receiving the position-retaining protruding edge is formed in the cylinder head, and a side wall of the mounting groove is located above the heat insulating sheet to prevent the heat insulating sheet from escaping from the position-retaining protruding edge.

5. The mechanism for sealing a cylinder and a cylinder head according to claim 4, wherein a second sealing ring is arranged at an outer periphery of the position-retaining protruding edge, and the second sealing ring seals a gap formed between the mounting groove and a side surface of the position-retaining protruding edge.

6. The mechanism for sealing a cylinder and a cylinder head according to claim 5, wherein both the first sealing ring and the second sealing ring are heat resisting sealing rings.

7. The mechanism for sealing a cylinder and a cylinder head according to claim 1, wherein the gas outlet portion is provided with a positioning groove for positioning and mounting the first sealing ring.
